(19) United States
(12) Patent Application Publication
(10) Pub. No.: US 2003/0148538 A1
(43) Pub. Date: Aug. 7, 2003

(54) Apparatus and method for fabricating high density microarrays and applications thereof

(76) Inventor: Kin Chiu Ng, Fresno, CA (US)

Correspondence Address: Bingham McCutchen LLP, Suite 1800, Three Embarcadero Center, San Francisco, CA, 94111-4067, US

(21) Appl. No.: 10/265,216

(22) Filed: Oct. 3, 2002

Related U.S. Application Data
(60) Provisional application No. 60/327,073, filed on Oct. 3, 2001.

(51) Int. Cl. B01L 3/00

(52) U.S. Cl. 436/180; 422/99; 422/58; 422/100

(57) ABSTRACT

The present invention relates to a devices and methods for decreasing the size of falling droplets in a controlled manner and precisely focusing their fall-line under the influence of gravity until they are deposited on a target surface. In this manner, extremely high spot density can be produced on a target such as a microscope slide. Such high spot density target surfaces will find use in, without limitation, high density bio-chips and lab-on-a-chip applications.

### RELATED APPLICATIONS

This application is related to and claims priority from U.S. Provisional Application Serial No. 60/327,073, filed Oct. 3, 2001, which is incorporated by reference as if fully set forth herein.

### FIELD OF THE INVENTION

The present invention relates to the field of analytical devices, chemistry, biochemistry, microarray formation and biochip fabrication.

### BACKGROUND OF THE INVENTION

The following is provided as background information only and is not intended, admitted, nor should it be construed, as prior art to the present invention.

“On demand” piezoelectric droplet generators have been used for quite some time in ink-jet printers (see, for example, M. Doring, “Ink-jet Printers,” Philips Tech, Rev, 1982, 7:192-198). The application of this technology to the fabrication of microarrays has been reported (A. Schober, et al., “System Integration of Microsystems/Chip Elements in Miniaturized Automata for High-Throughput Synthesis and Screening in Biology, Biochemistry and Chemistry,” Microsystems Technologies, 1997, 4:35-39). A number of patents have been issued on the use of piezoelectric droplet generators for the fabrication of microarrays (see, for example, U.S. Pat. Nos. 6,395,562; 6,365,378; 6,228,659 and 5,338,688 and WO publication WO 95/251116). The droplet generators in these references are essentially unmodified ink-jet print-heads in which droplet size is dictated by that required for efficient printing. That is, conventional ink-jet technology produces droplets that, when deposited on a target surface, result in spots on the order of 160 micrometers (μm) to 200 μm in diameter with about 250 μm between spots. With regard to microarrays, this translates to up to several tens of thousands of discrete spots per conventional glass microscope slide. It would be highly desirable to increase spot density and thereby increase the information that could be obtained from each slide. The obvious approach to increasing spot density is simply to reduce the size of the droplets and reduce the distance between deposited spots. Smaller droplets can be achieved by reducing the diameter of the ejector orifice. As the diameter of an orifice is reduced, however, problems can arise. Among these are clogging of the orifice, unintentional fragmentation of fragile substrates, such as, without limitation, polynucleotides, proteins, chromosomes, whole cells, etc. as they traverse the small orifice and difficulty in precisely controlling the deposition of extremely light-weight micro-diameter droplets due to environmental conditions.

What is needed is a device and method that still takes advantage of inexpensive ink-jet (i.e., piezoelectric) technology yet provides precise control of very small droplets which, when deposited on a surface, form small spots that can be closely spaced to ultimately give very high density arrays of spots. The present invention provides such a device and method as well as certain applications thereof.

### DESCRIPTION OF THE INVENTION

The present invention relates to a device and method for fabricating a high density microarray. The device comprises one or more droplet generator(s), a droplet charging element operatively coupled to the droplet generator(s), a droplet focusing element having an inlet and an outlet, the inlet being operatively coupled to the charging element, a droplet de-charging element operatively coupled to the outlet of the focusing element and an X-Y mounting stage operatively coupled to the outlet of the focusing element. The X-Y mounting stage is continuously, controllably movable in relation to the outlet of the focusing element. In an aspect of this invention, the charging element comprises a DC charging ring. In a further aspect of this invention, the focusing element comprises an AC quadrupole. De-charging each focused droplet element comprises using a grounding ring in an aspect of this invention.

In one aspect of this invention, the AC quadrupole comprises at least four elongate conducting rods each having a cross-section and a long axis. The long axis of each rod is parallel to the long axis of each of the other rods and forms an edge of a rectangular parallelepiped, the rods end-on describing a square. In an aspect of this invention, the rods are circular in cross-section. In another aspect of this invention each conducting rod independently comprises a metal, a conducting polymer or carbon.

In an aspect of this invention the above device comprises using two or more solvent liquids having different volatilities so that, as the droplet(s) fall through the focusing element, one or more of the solvent liquids evaporates causing the droplet to decrease in size. Suitable liquids for use in the methods of this invention include, but are not limited to water and glycerine.

The workpiece comprises a glass microscope slide, which may or may not be pre-treated. For example, pre-treatment of the glass slide comprises silanation.

By use of the above device, a deposited droplet having a diameter of less than 100 μm, or less than 50 μm, or less than 25 μm can be formed. Moreover, the plurality of deposited droplets can be spaced less than 100 μm, or less than 50 μm, or less than 25 μm, apart, edge to edge.

The X-Y mounting stage can comprise an X-direction motor and a Y-direction motor. In one aspect of this invention, the X-direction motor and the Y-direction motor are operatively coupled to a directional controller, such as a microprocessor.

In an aspect of this invention, the above device further comprises a droplet detecting element operatively coupled to the focusing element between the inlet of the focusing element and the grounding element.

In yet another aspect of this invention, the above device further comprises a droplet selecting element operatively coupled to the focusing element between the detecting element and the grounding element. The droplet selecting element can comprise an electrode having a charge opposite that of the droplet. The droplet selecting element can alternatively comprise an electrode having a charge that is the same as that of the droplet in an aspect of this invention.

Also provided by this invention is a method of forming a high density microarray, by dissolving or suspending a substrate in a liquid or a mixture of two or more liquids. A plurality of droplets of the substrate-containing liquid is generated one at a time, the droplets being released, also one at a time, such that each falls under the influence of gravity. The droplet(s) pass through a means to charge and focus the droplet(s) as they fall. As the charged droplet continues to fall, it is de-charged. The de-charged droplet(s) are deposited on to a planar surface of a workpiece. The workpiece is removably coupled to an X-Y mounting stage such that the workpiece surface is perpendicular to the path of the falling droplets. The mounting stage is continuously, controllably movable relative to the path of the falling droplets. Further provided is the microarray produced by this method, and methods for using the microarrays produced by the method.

In one aspect of this invention, depositing each focused droplet on a workpiece surface comprises moving the X-Y stage such that a pre-selected location on the workpiece surface is placed in the path of each falling droplet. This can be accomplished by moving the X-Y stage using an X-direction motor and a Y-direction motor under the control of a microprocessor in an aspect of this invention, such that each de-charged droplet is deposited at a different location on the workpiece surface.

In a further aspect of this invention, a method is provided for reacting and/or detecting an agent by: dissolving one or more first substrate(s) in a first solvent or first combination of solvents; dissolving one or more second substrate(s) in a second solvent or second combination of solvents that may be the same as, or different from, the first solvent or combination of solvents; generating a plurality of droplets, one at a time, of each first substrate-containing solvent; generating a plurality of droplets, one at a time, of each second substrate-containing solvent; depositing a plurality of first substrate droplets, one droplet at a time, at a plurality of different locations, one droplet per location, on the workpiece surface; depositing a second substrate droplet at each location where a first substrate droplet was deposited such that each different second substrate comes in contact with each different first substrate. In a further aspect, any reaction product so produced is detected. A positive and/or negative control can be employed where appropriate.

In the above method, the first substrates can comprise a plurality of different known or pre-selected polynucleotide sequences and the second substrate can comprise an unknown polynucleotide sequence. Detecting the reaction product comprises detecting hybridization of a first polynucleotide sequence with the second polynucleotide sequence. A positive and/or negative control can be employed where appropriate.

In another aspect, the first substrates comprise a plurality of different first small-molecules having a first functional group, the second substrates comprise a plurality of different second small-molecules having a second functional group and detecting a reaction product comprises detecting the product of a chemical reaction between each first functional group and each second functional group. A positive and/or negative control can be employed where appropriate.

In yet another aspect, of this invention, one or more first substrate(s) having a first functional group is/are dissolved in a first solvent or first combination of solvents, one or more second substrate(s) having a second functional group is/are dissolved in a second solvent or second combination of solvents that may be the same as, or different from, the first solvent or combination of solvents, a plurality of droplets of each first substrate-containing solvent is generated one droplet at a time, a plurality of droplets of each second substrate-containing solvent is generated one droplet at a time, a first-substrate droplet and a second-substrate droplet are released such that they collide in mid-air to form a combined droplet that falls under the influence of gravity, the combined droplet is charged and then focused as it falls and a reaction product of each first functional group with each second functional group is detected in the falling, focused, combined charged droplet using a droplet detector, e.g., a laser or a fluorescent microscope.

### BRIEF DESCRIPTION OF THE FIGURES

FIG. 1 is a schematic representation of a device of this invention.

FIG. 2 is a schematic representation of a droplet detecting element of this invention.

FIG. 3 is a schematic representation of a droplet sorting element of this invention.

FIG. 4 is a schematic representation of the use of multiple droplet generators in a device of this invention.

FIG. 5 is a schematic representation of a device of this invention in which droplets containing different substrates are combined in mid-air and the product of the reaction between functional groups on the different substrates is detected in the falling droplets.

FIG. 6 is a photomicrograph showing a microarray generated using the device and method of this invention.

### MODES FOR CARRYING OUT THE INVENTION

The present invention relates to devices and methods for decreasing the size of falling droplets in a controlled manner and precisely focusing their fall-line under the influence of gravity until they are deposited on a target surface. In this manner, extremely high spot density can be produced on a target such as a microscope slide. Such high spot density target surfaces will find use in, without limitation, high density bio-chips and lab on a chip applications.

Definitions

As used herein, certain terms may have the following defined meanings.

As used in the specification and claims, the singular form “a,” “an” and “the” include plural references unless the context clearly dictates otherwise. For example, the term “a droplet” includes a plurality of droplets, including mixtures thereof.

As used herein, the term “comprising” is intended to mean that the compositions and methods include the recited elements, but do not exclude others. “Consisting essentially of,” when used to define compositions and methods, is intended to mean excluding other elements of any essential significance to the combination. Thus, a composition consisting essentially of the elements as defined herein would not exclude trace contaminants from the isolation and purification method and pharmaceutically acceptable carriers, such as phosphate-buffered saline, preservatives, and the like. “Consisting of” is intended to mean excluding more than trace elements of other ingredients and substantial method steps for administering the compositions of this invention. Embodiments defined by each of these transition terms are within the scope of this invention.

The terms “polynucleotide” and “nucleic acid molecule” are used interchangeably to refer to polymeric forms of nucleotides of any length. The polynucleotides may contain deoxyribonucleotides, ribonucleotides, and/or their analogs. Nucleotides may have any three-dimensional structure, and may perform any function, known or unknown. The term “polynucleotide” includes, for example, single-stranded, double-stranded and triple helical molecules, a gene or gene fragment, exons, introns, mRNA, tRNA, rRNA, ribozymes, cDNA, recombinant polynucleotides, branched polynucleotides, plasmids, vectors, isolated DNA of any sequence, isolated RNA of any sequence, nucleic acid probes, and primers. A nucleic acid molecule may also comprise modified nucleic acid molecules.

“Hybridization” refers to a reaction in which one or more polynucleotides react to form a complex that is stabilized by hydrogen bonding between the bases of the nucleotide residues. The hydrogen bonding may occur by Watson-Crick base pairing, Hoogstein binding, or in any other sequence-specific manner. The complex may comprise two strands forming a duplex structure, three or more strands forming a multi-stranded complex, a single self-hybridizing strand, or any combination of these. A hybridization reaction may constitute a step in a more extensive process, such as the initiation of a PCR reaction, or the enzymatic cleavage of a polynucleotide by a ribozyme.

Examples of low stringency hybridization conditions include incubation temperatures of about 25° C. to about 37° C.; hybridization buffer concentrations of about 6×SSC to about 10×SSC; formamide concentrations of about 0% to about 25% and wash solutions of about 6×SSC. Examples of moderate hybridization conditions include incubation temperatures of about 40° C. to about 50° C.; buffer concentrations of about 9×SSC to about 2×SSC; formamide concentrations of about 30% to about 50%; and wash solutions of about 5×SSC to about 2×SSC. Examples of high stringency hybridization conditions include incubation temperatures of about 55° C. to about 68° C.; buffer concentrations of about 1 ×SSC to about 0.1×SSC; formamide concentrations of about 55% to about 75%; and wash solutions of about 1×SSC, 0.1×SSC, or deionized water. In general, hybridization incubation times are from about 5 minutes to about 24 hours, with 1, 2, or more washing steps, and wash incubation times are about 1, 2, or 15 minutes. SSC is 0.15 M NaCl and 15 mM citrate buffer. It is understood that equivalents of SSC using other buffer systems can be employed.

A “control” is an alternative subject, sample or solute used in an experiment for comparison purposes. A control can be “positive” or “negative.” For example, where the purpose of the experiment is to determine a correlation of an altered expression level of a gene with a particular type of cancer, it is generally preferable to use a positive control (a subject or a sample from a subject, carrying such alteration and exhibiting syndromes characteristic of that disease) and a negative control (a subject or a sample from a subject lacking the altered expression and clinical syndrome of that disease).

The term “peptide” is used in its broadest sense to refer to a compound of two or more subunit amino acids, amino acid analogs, or peptidomimetics. The subunits may be linked by peptide bonds. In another embodiment, the subunits may be linked by other bonds, e.g. ester, ether, etc. bonds. As used herein, the term “amino acid” refers to either natural and/or unnatural or synthetic amino acids, including glycine and both the D or L optical isomers, and amino acid analogs and peptidomimetics. A peptide of three or more amino acids is commonly called an oligopeptide if the peptide chain is short. If the peptide chain is long, the peptide is commonly called a polypeptide or a protein.

All numerical designations, e.g., pH, temperature, time, concentration, distance and molecular weight, including ranges, are approximations which are varied (+) or (−) by increments of 0.1. It is to be understood, although not always explicitly stated, that all numerical designations are preceded by the term “about”. It also is to be understood, although not always explicitly stated, that the reagents described herein are merely exemplary and that equivalents of such are well known in the art.

This invention provides a device for fabricating a high density microarray of a plurality of droplets of uniform size comprising a means for altering the size of a droplet located between a means for generating said droplet and a means for depositing said droplet. Use of the device provides a method for producing a plurality of uniformly sized droplets and a microarray containing these droplets which is useful, for example without limitation, in diagnostic and manufacturing procedures. The microarrays produced by the device and method are further provided herein.

In one aspect, the invention provides a device for fabricating a high density microarray having at least the following elements: a means for generating one or more droplet(s); a means for charging the droplet(s) operatively coupled to the droplet generator(s); a means for focusing the droplet, said means having an inlet and an outlet, wherein said inlet is operatively coupled to said charging means; a means for de-charging the droplet operatively coupled to the means for focusing the droplet; and, a means for creating an X-Y mounting stage operatively coupled to the means for focusing said droplet. In one aspect, the means for X-Y mounting is continuously, controllably movable in relation to the droplet focusing means. In another aspect, the means for creating the X-Y mounting stage comprises an X-direction motor and a Y-direction motor. In a further aspect, the means for creating the X-Y mounting stage comprises an X-direction motor and a Y-direction motor operatively coupled to a means for directionally controlling the same. An example of said controlling means includes, but is not limited to, a microprocessor.

An example of a means for charging said droplet includes, but is not limited to a DC charging ring. An example of a means for focusing said droplet comprises an AC quadrupole. In one aspect, the AC quadrupole comprises at least four, or alternatively at least 6, or alternatively at least 8, elongate conducting rods each having a cross-section and a long axis, wherein the long axis of each rod is parallel to the long axis of each of the other rods and forms an edge of a regular polyhedron. For example, in the case where four rods are used, each forms an edge of a rectangular parallelepiped. In a further aspect, the cross-section of each rod is circular. The conducting rods can independently be manufactured in the same or substantially the same manner and of the same or substantially the same materials, or each be different, or any combination thereof. Examples of suitable conducting materials for the rods include, but are not limited to, a metal, a conducting polymer or carbon. Readily available “drill-rod” and graphite are suitable materials for these rods.

In another aspect, the device further contains a means for detecting said droplet operatively coupled to the focusing mean wherein said detecting means is located between the inlet of the focusing means and the grounding means. For the purposes of illustration only, said detecting means comprises a light source such as a laser. As it is apparent to those of skill in the art and discussed in more detail infra, said detecting means will vary with the composition of and size of the droplet. In a further aspect, said detecting means includes a microscope, e.g., a fluorescent microscope.

In still another aspect, the device further comprises a droplet selecting means operatively coupled to the focusing means between the detecting means and the grounding means. An example of said droplet selecting means includes, but is not limited to, a means for separating said droplets based on their electrochemical properties, e.g., an electrode having a charge opposite that of the droplet.

An example of a means for generating said droplet, includes, but is not limited to, a piezoelectric droplet generator. When falling droplets impact a surface, the size of the spot formed is determined primarily by the size of the droplet. With a piezoelectric droplet generator, droplet size is determined primarily by ejector orifice diameter. As is discussed below, commercial ink-jet print-heads having standard orifice diameters can, if desired, be used as part of the device and method of this invention. However, to provide more flexibility in the design and operation of the device and method herein, piezoelectric droplet generators having different orifice diameters were fabricated using standard glass capillary tubes. The end of a capillary is melted shut and then carefully rotated against very fine sand paper or glass polishing medium to re-open the tip. In this manner, orifice diameters of from about 10 μm to about 100 μm were routinely achieved.

The capillary tube having a desired orifice can then be placed in a piezoelectric device, such as a piezoceramic tube, which is fixed in a holding device. Liquid is provided to the capillary from a reservoir connected to the capillary by flexible tubing. The piezoceramic tube is then connected to an electronic signal generator. Applying a voltage pulse to the piezoceramic tube compresses the capillary causing a droplet of liquid to be ejected from the capillary tip. The rate of droplet formation is controlled by the frequency of the voltage pulse. In this manner, extremely uniform droplets can be generated. For example, Ulmke, et al., “The Piezoeletric Droplet Generator—A Versatile Tool for Dispensing Applications and Calibration of Particle Sizing Instruments,” Precision Engineering—Nanotechnology, Proceedings of the 1^{st} International Euspen Conference, 1999, 2: 290-293, reported using a similar device to make droplets having diameters between 10 μm and 100 μm and examining their size uniformity. Using appropriately sized capillaries, Ulmke, et al., 1999, created water droplets of 21 μm, 53 μl m and 86 μm diameters. Using phase-Doppler anemometry (PDA); they found standard deviations of 0.4 μm for the 21 μm droplets and 0.8 for the 53 μm and 86 μm droplets over 10,000 measured droplets.

It would appear, then, that optimal droplet size could be achieved simply by manipulating the orifice diameter of a droplet generator. Such, however, is not the case in practice. The characteristics of the liquid and any substrate dissolved or suspended in the liquid must also be considered. The dependency of droplet size on the viscosity of the liquid from which the droplet is being formed depends on a multitude of complex factors. With regard to substrates, small entities, such as small organic molecules, will traverse almost any size orifice without difficulty. On the other hand, macromolecules such as, without limitation, synthetic polymers, natural high molecular weight species such as complete DNA strands, chromosomes, proteins and whole cells may clog small ejector orifices. In addition fragile entities such as chromosomes and whole cells may undergo fragmentation as they are forcibly ejected from the capillary. The solution to this problem, and an aspect of this invention, is a means for manipulating the size of droplets after they have been ejected from the droplet generator. An example of such means is described below.

As noted previously, the size of a spot formed on a substrate by deposition of a falling droplet is determined by the size of the droplet. The smaller the droplet when it impacts the target surface, the smaller the resulting spot. Smaller spots (plus less distance between spots) equates to increased spot density. In conventional ink-jet technology, the orifice of the print head is in close proximity to the surface on which the ink is being deposited. Thus, the size of a droplet when it impacts the target surface is essentially the same as its size when initially generated. It is an aspect of this invention to increase the distance between the locus of droplet generation and the target, so that, as the droplet falls, some of the liquid evaporates before the droplet impacts the target surface. The amount of evaporation and, consequently, the ultimate size of the droplet can be controlled by varying the volatility of the liquid(s) used to form the droplet and the distance that the droplet falls before it impacts the target. Thus, if highly volatile liquids such as, without limitation, carbon disulfide, ethyl ether, dichloromethane, methanol, ethanol or water are used, depending on the distance the droplet is allowed to fall, substantial evaporation and corresponding reduction in droplet diameter will occur. On the other hand, if relatively non-volatile liquids such as, without limitation, dimethylsulfoxide, pyridine, tributylamine, ethylene glycol or glycerol are used, very little, if any, evaporation will occur unless the droplet is permitted to fall very long, and therefore impractical, distances. A particularly advantageous approach to droplet size control, and another aspect of this invention, is to use a combination of high and low volatility liquids. In this manner ultimate droplet size can be controlled based on the ratio of the volume of the low volatility liquid to the high volatility liquid since, depending on the distance the droplet is permitted to fall, most or all of the high volatility liquid will evaporate before the droplet strikes the target surface. It is not necessary, of course, that all of the high volatility liquid evaporate. For any combination of liquids, the reduction in size of droplets for any distance of fall is easily empirically determined.

Further provided by this invention is a method for forming and/or detecting said droplets using the devices described herein. In one aspect, the droplets are detected by use of a high density microarray. Thus, in another aspect, the invention provides a method of forming a high density microarray by generating a plurality of droplets one at a time, wherein said droplets comprise a dissolved or suspended substrate in a liquid or a mixture thereof, and releasing said droplets, one at a time, through a means that electrically charges and focuses said droplets such that each falls under the influence of gravity. The charged droplet is then de-charged as it continues to fall and deposited releasably on a planar workpiece surface, e.g., a glass slide that may, in one aspect, be pre-treated by silanation with, for example without limitation, hexamethyldisilazane. As is known to those of skill in the art, a pre-treatment may be selected to impart preferred properties to the workplace and/or combination workplace and droplet after deposition of the droplet on the workplace. For example, the plate may be pre-treated with a “control” or alternatively with a reactant such as a polynucleotide.

In an aspect of this invention, the liquid in which solutes are dissolved or suspended comprises a plurality of liquids having different volatilities, so that, as a droplet falls through the focusing means, one or more of the liquids evaporates causing the droplet to decrease in size. Examples of liquid/liquid combinations include, but are not limited to, water and glycerine, ethylene glycol and methyl alcohol, and polyethylene glycol (molecular weight less than 630) and water. Polyethylene glycol(s) greater than 630 molecular weight are solids that can be dissolved in water, methyl alcohol, or ethyl alcohol, resulting a mixture that can be used for droplet production. An example of a means for de-charging each focused droplet includes, but is not limited to, a grounding ring.

The device and method of this invention provides a plurality of deposited droplets that are less than 100 μm apart, or alternatively less than 50 μm, or alternatively less than 25 μm apart, circumference to circumference (edge to edge). An advantage of the method of this invention is that it can provide a microarray wherein the distance between droplets may be the same or different and the droplets themselves may be of the same size (diameter) or different sizes on the same micro array.

Thus, the location of each said droplet on the workpiece surface may be pre-determined by moving the X-Y stage such that a pre-selected location on the workpiece surface is placed in the path of each falling droplet.

The device and means herein also provides a means and method for reacting two or more reactants in micromolar amounts. For example, one or more first substrate(s) is dissolved in a first solvent or first combination of solvents and one or more second substrate(s) is dissolved in a second solvent or second combination of solvents that may be the same as, or different from, the first solvent or combination of solvents. A plurality of droplets is then generated, one at a time, of each first substrate-containing solvent and a plurality of droplets is generated, one at a time, of each second substrate-containing solvent. The first substrate droplets are deposited at different locations, one droplet per location, on a workpiece surface and the second substrate droplet is deposited on the workpiece such that each different second substrate comes in contact with each different first substrate. The deposited first and second droplets are deposited, and may be stored, under conditions suitable to promote one or more reactions between or among the substrates in the droplets. In a further aspect, any reaction product so produced is detected by methods well known in the art.

For the purpose of illustration only, the first droplets may contain one or more of a polynucleotide which after deposition, is stored under conditions suitable for hybridization with one or more of another polynucleotide contained in the second droplets. Means for detecting the hyrbridization products are well known in the art and commercially available.

Additional examples of solutes include, but are not limited to, small molecules, peptides, ligands and antibodies. Said solutes can further comprise a plurality of different first small-molecules having a first functional group and a plurality of different second small-molecules having a second functional group wherein any reaction product formed by the reaction of the first and second functional groups is detected. One or both of the solutes can be “detectably labeled” prior to being combined or, alternatively, the reaction product itself can be detected. An example of detectable labeling is, without limitation, using fluorescent dyes which, when the hybridization occurs, generate a detetctable FRET signal An example, without limitation, of reaction product detection is the infrared spectrometric detection of an amide formed by the reaction of an ester with an amine.

In a further aspect, the first and second substrate droplets are released such that they collide in mid-air to form a combined droplet that falls under the influence of gravity. The combined charged droplet is charged and focused as it falls. Any reaction product formed by the combination of the first and second droplets may be detected as described herein.

One of skill in the art can control and select for droplet size and/or a preferred reaction product among others by pre-selection of the variables as described herein. For example, it is possible, and it is an aspect of this invention, to heat the fall-line of droplets to increase the rate of evaporation. Thus, using either or both fall distance and heating could theoretically render initial droplet size essentially irrelevant and, as indicated previously, a standard ink-jet print head could be used. However, as also noted above, deposited spot size is dependent on droplet size. To achieve extremely small spots requires extremely small droplets which brings up the problem of droplet directional control. As droplets become smaller and smaller, they tend to be influenced to a greater extent by environmental conditions such as convection currents set up by a heater, vibrations, minute changes in pressure, etc., which can drive them off course, i.e., off a perfectly vertical fall-line. One approach to controlling environmental factors is simply to enclose the fall path of droplets in a protective vessel and such is an aspect of this invention. In a presently preferred embodiment of this invention, a glass or plexiglass enclosure surrounds at least the fall-line of droplets from the ejector tip to just above the target surface. If desired, the entire apparatus may be so enclosed. Even this may not be sufficient as the size of droplets is decreased and their deposition density is increased such that extremely precise control is required. Thus, an aspect of this invention is directional control of very small falling droplets through the use of a focusing device.

### EXAMPLES

The following focusing device and method is but one embodiment of this invention and, as such, is not intended, nor is it to be construed, to limit the scope of this invention in any manner. Other such devices and methods may become apparent to those skilled in the art based on the disclosures herein; all are deemed to be within the scope of this invention.

### Example 1

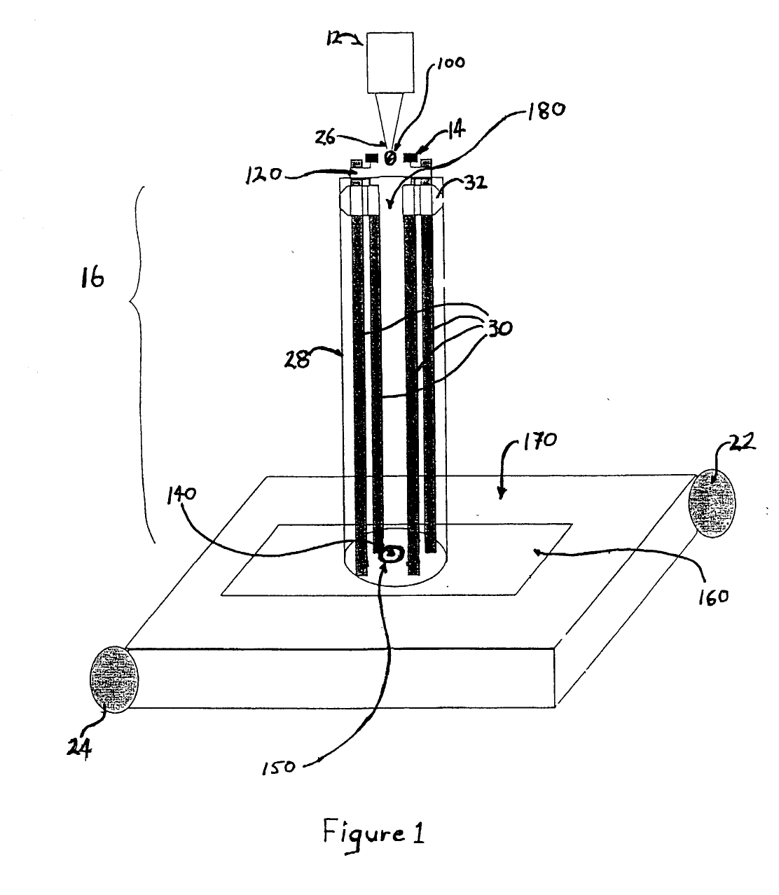

In one aspect, focusing of droplet is accomplished through the influence of an AC quadrupole on charged droplets. This is shown schematically in FIG. 1. Thus, droplet 100 is formed at the ejector tip 26 of droplet generator 12. Droplet generator 12 can be any manner of droplet generator known in the art. For example, without limitation, droplets may be generated passively by the weight of liquid in a reservoir attached to a generator tip having an orifice of a desired size. Preferably, however, the droplet generator is of an active sort so precise control can be had, not only over droplet size but droplet generation rate as well. It is presently preferred to use a piezoelectric droplet generator in the device and method of this invention. The piezoelectric generator can be a commercial ink-jet print head or it can be a custom generator using capillary ejectors such as that described above.

After droplet 100 detaches from ejector tip 26, it falls under the influence of gravity through direct current (DC) charging ring 14, which imposes a charge on the droplet. DC charging ring is isolated from quadrupole 16 by insulator 120. Insulator 120 can be any insulating material known in the art such as, without limitation, glass, ceramic, wood, rubber or a non-conductive polymer such as, again without limitation, Teflon™. The charged droplet then continues to fall under the influence of gravity and enters AC quadrupole 16 through inlet 180, wherein electrodynamic forces direct the path of fall (the “fall-line”) of the droplet.

Quadrupole 16 comprises four conductive rods 30 mounted in parallel. Rods 30 may be constructed of any conducting material such as a metal, a conductive polymer or carbon. Presently preferred rods are constructed of a metal such as, without limitation, stainless steel, copper, brass, iron or aluminum. The parallel rods are held by mounting bracket 32 such that they form a rectangular parallelepiped having a square cross-section when viewed end on. Rods 30 may be of any shape and size that will result in the creation of a uniform electrical field when a charge is applied to them. In a presently preferred configuration, rods 30 are circular in cross-section and have a diameter typically of about 1 to 2 millimeters (mm). The distance between rods 30 is likewise variable and depends on the amount of current to be applied to the rods, its frequency and the intensity of the desired field. In a presently preferred configuration, rods 30 are approximately 0.5 centimeters (cm) apart. Rods 30 can be any length. However, for the sake of compactness and ease of operation, it is presently preferred that they be from about 5 cm to about 15 cm long. A power supply (not shown) is connected to one end of each rod 16 such that a 180° phase difference is created at each pole relative to that of the pole of its nearest neighbor rod. The electric field generated in the enclosed volume defined by rods 30, i.e., within quadrupole 16, then directs the charged droplet along the axis of quadrupole 16 until it reaches outlet 140 where the droplet is discharged by de-charger 150. The discharged droplet then exits the device through outlet 140 and free-falls for a short distance until it impacts target surface 160. Outlet 140 may be any desired distance above target surface 160, although it is presently preferred that the free-fall distance of the droplet be from about 1 mm to about 2 mm. However, at not time does outlet 140 or any other part of quadrupole 16 come in contact with target 160.

The frequency of the AC current applied to the quadrupole is dictated by the desired droplet size. Thus, for a 15 μm diameter droplet, 60 Hz AC works well but with a 5 μm droplet, the preferred frequency is 120 Hz. The optimal frequency is readily empirically determined.

The location of a droplet on target surface 140 is controlled by mounting stage 170. Target surface 140 is securely, but removably, attached to mounting stage 170 such that it is perpendicular to the fall-line of the droplets. Mounting stage 170 then is moved in a plane perpendicular to the droplet fall-line until a desired location on the target is situated beneath outlet 140 of quadrupole 16. While any manner of moveable stage may be used, it is presently preferred that the mounting stage be an X-Y robot. That is, mounting stage 170 comprises a X-direction motor 22 and a Y-direction motor 24. X-direction motor 22 moves the mounting stage in a one direction in the above-described perpendicular plane while Y-direction motor 24 moves the stage in a direction orthogonal to that of the X-motor 22. Working together, the two motors provide continuous control of the position of the mounting stage such that any point on target surface 140 may be brought to a location in the fall-line of a droplet.

The X-Y robot is controlled by a motor-controller and a microprocessor (not shown). Software is used to program the motor-controller for stage movements. The microprocessor coordinates the movement of the mounting stage with the frequency of droplet ejection from the outlet of the quadrupole such that any number of droplets can be deposited at any location on the target. Thus each droplet can be deposited at a different location on the target in any desired pattern. Or, if so desired, more than one droplet can be deposited at one location as in the case of polynucleotide hybridization analyses or combinatorial chemical reaction studies, each of which is discussed below.

In FIG. 1, the fall-line within quadrupole 16 is shown enclosed in protective tube 28, which may be of any desired material but most conveniently is a transparent material such as, without limitation, glass or plexiglass.

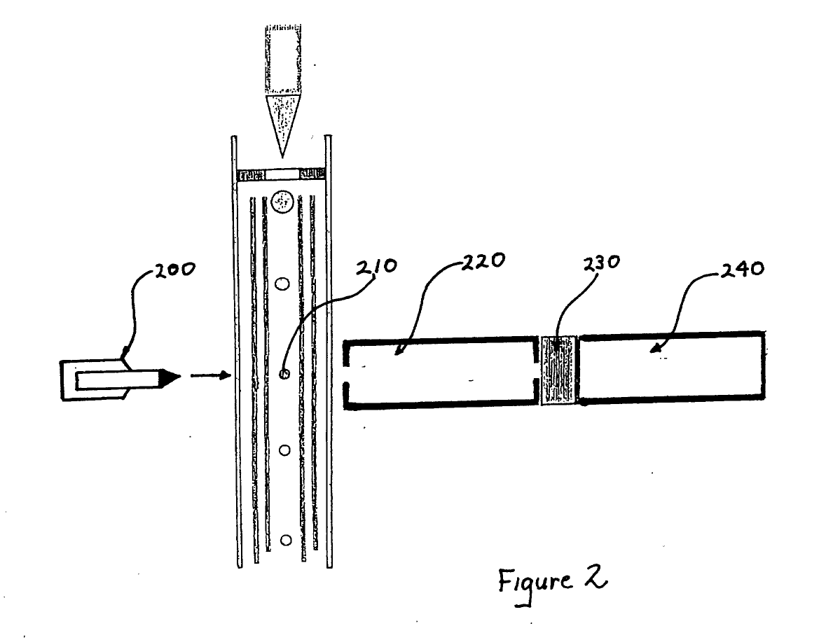

Since the use of a quadrupole focusing element in the present invention very precisely positions each charged droplet in exactly the same position in its field, it is possible, and it is an aspect of this invention, to examine droplets and their contents “on the fly” by adding a droplet detector to the device herein. Such a device is schematically depicted in FIG. 2. While any manner of detection device can be used with the device and method of this invention depending on the information desired from the droplet, a presently preferred detector comprises a laser and fluorescence microscope. Thus laser 200 illuminates droplet 210 as it passes by. Since the location of each droplet is the same, fluorescence generated by the substrate in each droplet can be precisely focused by fluorescence microscopic objective 220 and directed through spectral filter 230 to detector 240. Detector 240 can be cooled to suppress noise or background, making the signal more pronounced. Other detection systems will become apparent to those skilled in the art based on the disclosures herein, such as, without limitation, droplet size detectors, number of substrate molecules per drop detectors, infrared spectrophotometic detectors that detect functional groups on molecules, etc. All such detector are within the scope of this invention.

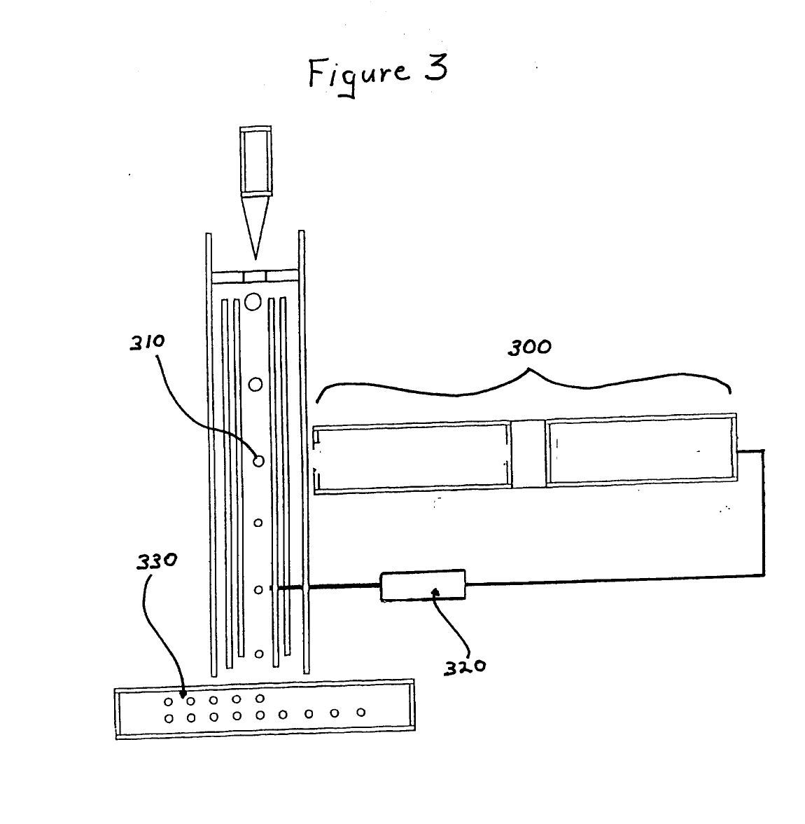

As mentioned previously, droplet size can be quite well controlled by the appropriate selection of generator ejection orifice diameter. However, when using a standard ink-jet print-head droplet generator, droplet size may not be as precisely controllable as desired. Furthermore, other factors might affect the uniformity of droplets with regard to size, droplet content, etc., even when a custom generator is used. Thus, it is an aspect of this invention to include a droplet selector coupled with a droplet detector in a device herein. Such a droplet selector is depicted schematically in FIG. 3.

An appropriate droplet detector 300 is first used to examine a desired characteristic of droplet 310 as is falls by. As noted above, this characteristic can be anything that is observable, instrumentally or otherwise, such as, without limitation, droplet size, amount of substrate in the droplet, the presence or absence of a particular chemical functional group or mixture of functional groups, etc. If a droplet is detected that is out of specification with regard to the parameter being detected, droplet selector 320 is activated. Droplet selector 320 comprises an electrode having a charge opposite that of droplet 310. Thus, when activated, droplet selector 320 will attract and trap droplet 310, removing it from the system such that it will not to be deposited on target surface 330. Droplet selector 320 may, in the alternative, comprise an electrode having the same charge as the droplets so that unwanted droplets are displaced from the fall-line by repulsion and do not exit the outlet of the quadrupole.

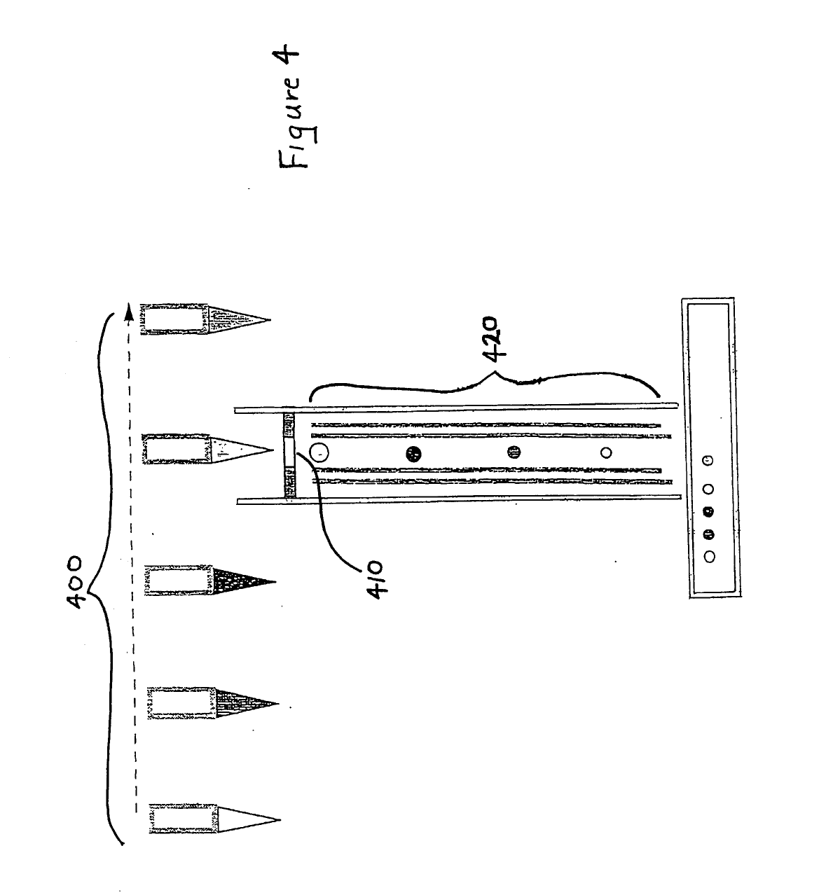

The above discussion relates to a device and method that comprises a single droplet generator. However, it is possible, and it is an aspect of this invention, to use multiple droplet generators. This is schematically depicted in FIG. 4. In this embodiment, multiple droplet generators 400 move across input port 410 of AC quadrupole 420. As each droplet generator passes over the inlet, it ejects a droplet, which is then treated exactly as a single droplet from a single generator as described above. The difference is that a large number of different substrates can be placed on a single target surface in a predetermined pattern. In this manner, so called “bio-chips” and “labs on a chip” can be fabricated.

Bio-chips are targets on which a large number of different biomolecules have been deposited. Often the target surface is a conventional microscope slide but any manner of target can be used. Each different biomolecule is capable of interacting with another biomolecule, usually with one-to-one specificity, that is, each biomolecule will react with one and only one other biomolecule. Thus, when a known array of deposited biomocules is contacted with an unknown biomolecule, an interaction will occur between the unknown and one of the known biomolecule so as to produce a detectable signal. The signal or, sometimes the pattern of signals, can be used to identify the unknown biomolecule. Among the analytical biochips presently in use are gene chips, protein chips, chromosome chips, DNA chips and whole cell chips. In each of these instances, the chip can be used to rapidly identify an unknown material.

An illustrative type of biochip is one on which a large number of known sequence polynucleotide fragments are placed on a surface using the device and method herein. The chip is then contacted with a solution of a polynucleotide fragment of unknown sequence and the hybridization of the unknown fragment with a known fragment, which hybridization is rendered detectable through the use of, for example, a fluorescence indicator, serves to identify the sequence of the unknown fragment.

The “lab on a chip” comprises one or more first reactants that are arrayed on a microscope slide. One or more second reactants are then deposited on the chip with each second reactant being deposited at the same location as a first reactant. The reactants react to give a product which then can be isolated or used in a further study such as, without limitation, screening for antimicrobial agents.

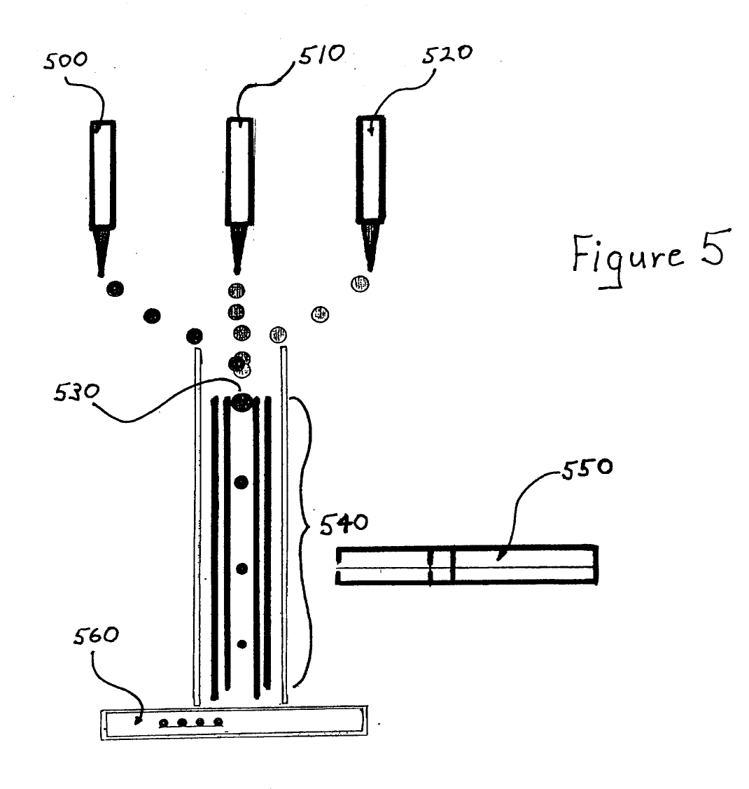

It is also possible, and it is an aspect of this invention, to produce two or more droplets essentially simultaneously from two or more different droplet generators that are disposed such that the droplets collide in mid-air in the vicinity of the quadrupole inlet. This is depicted in FIG. 5. Thus droplet generators 500, 510 and 520 each generate a droplet. The droplets are projected to a location above inlet 530 of quadrupole 540 where they collide. They are then charged and focused by the device of this invention. Depending on the substrates in each of the droplets, a detectable event, such as, without limitation, a chemical reaction, a physical attraction (e.g., hybridization) a change in a physical state such as energy level, molecular conformation, optical rotation, color, etc. occurs. The event is then observed at an appropriate detector 550, after which the combined droplet is deposited on target surface 560.

An aspect of this invention is the use of treated target surfaces, e.g., silanated glass. Thus use of treated targets helps to eliminate, or at least assuage, problems with droplet deposition caused by charge attraction or repulsion due to accumulated charge on the target surface.

### Example 2

Glycerine (glycerol) and water make a particularly attractive two liquid system for use in the device and method of this invention although others will become apparent to those skilled in the art based on the disclosures herein and are deemed within the scope of this invention.

Glycerine and water are completely miscible and are well-suited for use with biomolecules. Glycerine is relatively non-volatile compared to water and droplets formed from a glycerine/water mixture will lose water through evaporation during free-fall through the device of this invention.

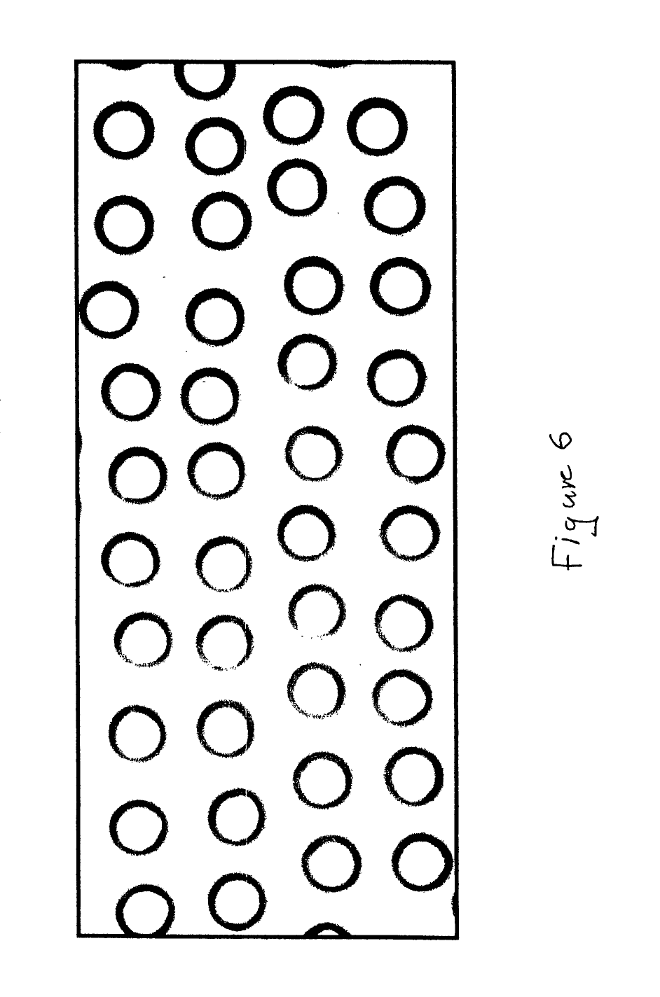

Thus, a 5% glycerol/water solution was prepared. A piezoelectric generator having a 30 μm ejector orifice was used to generate droplets. The droplets were charged using a DC charging ring having a voltage of about 100 volts. The charged droplets were then focused by an about 700 VAC AC quadrupole generating about a 60 Hz electric field. The length of the quadrupole was 10 cm. Circular cross-section stainless steel rods about 1.6 mm in diameter placed 5 mm (center to center) apart were used. After traversing the length of the quadrupole, the droplets were deposited on a silanated glass slide. FIG. 6 shows the resulting pattern of 15 μm spots deposited in this manner.

Although certain embodiments and examples have been used to describe the present invention, it will be apparent to those skilled in the art that changes in the embodiments and examples shown may be made without departing from the scope of this invention. All such changes are thus within the scope of this invention.

All references cited herein are incorporated in their entirety into the present disclosure.

What is claimed:

1. A device for fabricating a high density microarray, comprising:
a droplet focusing element having an inlet and an outlet, the inlet being operatively coupled to a droplet charging element;
a droplet de-charging element operatively coupled to the outlet of the focusing element; and,
an X-Y mounting stage operatively coupled to the outlet of the focusing element, wherein, the X-Y mounting stage is continuously, controllably movable in relation to the outlet of the focusing element.

2. A device for fabricating a high density microarray, comprising:
a means for a means for altering the size of a droplet located between a means for generating said droplet and a means for mounting said droplet.

3. The device of claim 1, further comprising a droplet generator.

4. The device of claim 1, wherein the X-Y mounting stage comprises an X-direction motor and a Y-direction motor.

5. The device of claim 4, wherein the X-direction motor and the Y-direction motor are operatively coupled to a directional controller.

6. The device of claim 1, further comprising a droplet detecting element operatively coupled to the focusing element between the inlet of the focusing element and the grounding element.

7. The device of claim 1, further comprising a droplet selecting element operatively coupled to the focusing element between the detecting element and the grounding element.

8. The device of claim 7, wherein the droplet selecting element comprises an electrode having a charge opposite that of the droplet.

9. A method of forming a high density microarray, comprising:
generating a plurality of droplets of a substrate-containing liquid, one at a time;
releasing the droplets, one at a time such that each falls under the influence of gravity and through a means to control the size of said droplet and depositing said de-charged droplet on a planar surface of a workpiece that is removably coupled to an X-Y mounting stage such that the workpiece surface is perpendicular to the path of the falling droplets.

10. The method of claim 9, wherein said liquid comprises two or more liquids of differing volatilities.

11. The method of claim 9, wherein depositing each focused droplet on a workpiece surface comprises moving the X-Y stage such that a pre-selected location on the workpiece surface is placed in the path of each falling droplet.

12. A method of forming a high density microarray comprising depositing a plurality of droplets onto a mounting device using the device of claim 2.

13. A microarray produced by the method of claims 9 or 12.

14. The microarray of claim 13, wherein each of said deposited droplet is of a uniform size and has a diameter of less than 100 μm.

15. The microarray of claim 13, wherein each of said deposited droplets are less than 100 μm apart, edge to edge.

16. The microarray of claim 14, wherein the plurality of deposited droplets are less than 100 μm apart, edge to edge.

17. A method for the detection of an agent, comprising:
dissolving one or more first substrate(s) that reacts with said agent under suitable conditions to produce a reaction product, in a first solvent or first combination of solvents;
dissolving one or more second substrate(s) suspected of containing said agent in a second solvent or second combination of solvents that may be the same as, or different from, the first solvent or combination of solvents;
generating a plurality of first droplets, one at a time, of each first substrate-containing solvent;
generating a plurality of second droplets, one at a time, of each second substrate-containing solvent;
altering the size of said first droplets and said second droplets before each is deposited at a plurality of locations, one said first droplet and one said second droplet per location, on the workpiece surface under conditions favorable for the formation of said reaction product; and,
detecting a reaction product at each location.

18. The method of claim 17, wherein said agent is selected from the group consisting of a polynucleotide, a small molecule, a peptide, a protein and a ligand.

19. The method of claim 18, wherein said contact comprises releasing a first-substrate droplet and a second-substrate droplet such that they collide in mid-air to form a combined droplet that falls under the influence of gravity.
